(19) United States
(12) Patent Application Publication
(10) Pub. No.: US 2019/0243016 A1
(43) Pub. Date: Aug. 8, 2019

(54) METHOD FOR CHARACTERISING THE UNDERLYING GROUND OF A REGION USING PASSIVE SEISMIC SIGNALS, AND CORRESPONDING SYSTEM

(71) Applicant: STORENGY, Bois Colombes (FR)

(72) Inventors: Frédéric Huguet, Fosses (FR); Alexandre Kazantsev, Paris (FR); Damien Lavergne, Sartrouville (FR); Patrick Egermann, Cahors (FR)

(21) Appl. No.: 16/311,259

(22) PCT Filed: Jun. 20, 2017
(86) PCT No.: PCT/FR2017/051622

§ 371 Date: Dec. 19, 2018

(30) Foreign Application Priority Data
Jun. 23, 2016 (FR) 1655858

(51) Int. Cl. G01V 1/28

(52) U.S. Cl. CPC G01V 1/288; G01V 2210/60

(57) ABSTRACT

A method of characterizing a subsurface of a region includes preparing a plurality of spectra illustrating a spectral density of passive seismic signals obtained in a vicinity of a surface of the region at one or more points of the region where recordings are made of the passive seismic signals. Each spectrum is prepared from an associated signal representative of a movement. The method also includes determining at least one spectral attribute for each frequency appearing in each spectrum so as to obtain a set of spectral attributes associated with the recordings and with the frequencies. The method further includes organizing the set of spectral attributes in a matrix in which each row is associated with one of the recordings. In addition, the method includes applying a principal component analysis method to the matrix in order to determine principal components and deduce therefrom one or more characteristics of the subsurface.

### BACKGROUND OF THE INVENTION

The invention relates to the general field of characterizing the subsurface of a region, in particular by studying passive seismic signals, and most particularly by studying low frequency passive seismic signals.

Low frequency passive seismic signals are signals representing movements of ground that appear naturally at frequencies in the range 0.1 hertz (Hz) to 10 Hz, or indeed 0.1 Hz to 4 Hz or 5 Hz. In these frequency ranges, the movements of ground may be associated with movements of waves in the ocean producing waves that propagate inside land above sea level. Waves at frequencies above 1 Hz can also be generated by human activity (roads, industry).

It should be understood that the term “passive” is used herein to mean that there is no generation of seismic signals by a user or by a tool controlled by a user.

It should also be observed that the above-mentioned frequency ranges are distinct from those involved with high frequency seismic signals, which may lie in the range 10 Hz to 150 Hz, and which relate in particular to observing induced seismicity.

The document “Phenomenology of tremor-like signals observed over hydrocarbon reservoirs” (S. Dangel et al., Journal of Volcanology and Geothermal Research) describes that a frequency peak lying in the range 1.5 Hz to 4 Hz in the spectra of signals is to be observed above an underground reservoir that contains hydrocarbons (and thus a plurality of fluids or a plurality of phases of the same fluid). As a result, observing such signals makes it possible to determine whether a plurality of fluids or a plurality of phases of a single fluid are present in the subsurface in a region.

Under such circumstances, by studying low frequency passive seismic signals, it is possible to track variation in a reservoir used for storing hydrocarbons (e.g. natural gas), or steam, or various types of gas (e.g. CO₂, H₂), or indeed it is possible to perform operations of prospecting for hydrocarbons or aquifers containing water and steam in the geothermal field.

In the state of the art, the following documents are known:

Document US 2008/0021656 describes a method of processing seismic data in which passive seismic signals are acquired, spectra of these signals are obtained, the ratio between the vertical components of the spectra and the horizontal components of the spectra is calculated, and the ratio is integrated. In order to perform the method described in that document, it is necessary to select a frequency range in which the processing is to be performed. That solution is not sufficiently flexible, and the results obtained with that method are not sufficiently accurate.

Document WO 2010/080366 discloses a method of detecting hydrocarbons by using passive seismic data in combination with geophysical data of some other type (e.g. active seismic data).

Document WO 2009/027822 proposes a method of determining the positions of hydrocarbon reservoirs in which seismic data is obtained, spectra are obtained from signals, and the maxima of those spectra are determined in order to obtain a map.

Document EP 2 030 046 also describes a method in which ratios between the amplitudes of spectra are studied. It also describes smoothing spectra.

Document EP 1 960 812 and Document EP 2 030 046 describe methods in which seismic data is obtained, spectra are obtained from the seismic data and the spectra are smoothed.

Document WO 2009/081210 describes a method in which energy is determined in a frequency band of a spectrum that has been obtained by taking measurements of movement under the surface.

Document US 2014/0254319 describes acquiring passive seismic signals. That document proposes using a lowpass filter for frequencies in the range 0 to 5 Hz, since it is at those frequencies that phenomena are observed on the basis of passive seismic signals. In that document, the signals are transformed into the frequency-wave number domain.

Document WO 2014/108843 describes a method in which micro-seismic signals are acquired and subjected to convolution followed by applying a filter.

The solutions described in those documents are not satisfactory. They do not make it possible to determine in sufficiently accurate manner whether different fluids or phases are present in the subsurface of a region. Specifically, those methods are very sensitive to anthropic noise, and it can be difficult to distinguish accurately between regions where fluids are present and other regions.

Certain methods require prior determination of a frequency range that is to be observed. That solution is not satisfactory since it does not take account of anomalies that appear outside the frequency range that is to be observed.

The invention seeks in particular to mitigate those drawbacks.

### OBJECT AND SUMMARY OF THE INVENTION

The invention satisfies this need by proposing a method of characterizing the subsurface of a region, the method comprising the following steps:
preparing a plurality of spectra illustrating the spectral density of passive seismic signals obtained in the vicinity of the surface of said region at at least one point of said region where a recording is made of passive seismic signals are recorded, each spectrum being prepared from a signal illustrating a movement;
determining at least one spectral attribute for each frequency appearing in each spectrum so as to obtain a set of spectral attributes associated with recordings and with frequencies;
organizing said set of attributes in a matrix in which each row is associated with a recording; and
applying a principal component analysis method to said matrix in order to determine principal components in order to deduce therefrom the characteristics of said subsurface.

It may be observed that the movements may be sensed as movement speed signals or indeed as movement acceleration signals. Preferably, movement speed signals are used. It can also be observed that the movements may take place in three directions (one vertical direction and two horizontal directions), and that spectra can be prepared that are associated with vertical movements only and/or spectra that are associated with horizontal movements only.

The dimensions of the resulting matrix are the number of recordings multiplied by the number of frequencies for each attribute (the number of frequencies per attribute may differ for different attributes).

The inventors have observed that by using a principal component analysis method, principal components are obtained that show up more easily the differences between spectra corresponding to different recordings. Specifically, the principal components space is the best space for representing differences between the spectra.

As a result, this space is a good space in which to deduce the characteristics of the subsurface of said region.

If a plurality of points are studied, and by using principal components, it is possible to obtain a graphical representation of the region, which representation shows the presence of underlying fluids. If only one point is studied by means of a plurality of signals acquired at different instants, it is possible to observe variations over time, insofar as the quantity of fluid varies over time.

Principal component analysis is commonly referred to by the person skilled in the art by its abbreviation: PCA.

Thus, it can be understood that the spectra that are obtained are samples and that they present a finite number of frequencies. These frequencies may be selected in a broad frequency range, e.g. a frequency range from 0.1 Hz to 4 Hz or 5 Hz. There is no need to define a narrower frequency range for performing the invention, even though that is necessary in the method described in Document US 2008/0021656.

It can also be observed that the attributes may be any parameter that characterizes a frequency of the spectrum and that varies when the point of the region is vertically above a zone containing fluids. Thus, by using a plurality of attributes, the invention differs from the solution described in Document US 2008/0021656 in which the only attribute that is used is the ratio between the vertical and horizontal movements. The inventors have observed that by using a plurality of attributes, the presence of fluids can be detected effectively.

Furthermore, in the present invention, the passive seismic signals may be obtained by means of seismometers, such as the apparatus sold by the Canadian supplier Nanometrics under the trade name “T-40”. Such apparatus may be buried in the vicinity of the surface of the region, e.g. at a depth of about fifty centimeters. Alternatively, it may be placed on the surface, providing the surface is well coupled to the ground.

In a particular implementation, said movements are vertical movements and/or horizontal movements, and said spectral attributes for each frequency are of types selected from the group formed by the ratio between the spectral density for vertical seismic movements and the spectral density for horizontal seismic movements, the derivative of the spectral density as a function of frequency for the horizontal seismic movements, and the derivative of the spectral density as a function of frequency for the vertical seismic movements.

The inventors have observed that by combining a plurality of these spectral attributes it is possible to obtain effective detection of the presence of fluids.

In a particular implementation, said derivative of the spectral density as a function of frequency for the horizontal seismic movements and/or said derivative of the spectral density as a function of frequency for the vertical seismic movements are calculated by applying a linear regression around a selected number of spectral points.

The selected points may be obtained by dividing the frequency axis into spans of 0.5 Hz.

In a particular implementation, preparing each spectrum from a signal comprises:
dividing the signal into a plurality of consecutive sub-signals all having the same duration:
preparing a spectral density sub-spectrum for each sub-signal;
for each frequency of the sub-spectra, determining a statistical attribute (e.g. the median) of the spectral density from the spectral density values for that frequency in each sub-spectrum; and
obtaining said spectrum that is to be prepared from all of the statistical attributes of all of the frequencies.

This particular implementation serves to obtain good smoothing of the spectra, since use is made of statistical attributes such as medians.

In a particular implementation, each sub-signal overlaps the preceding sub-signal over at least a non-zero duration of the preceding sub-signal, e.g. 50% of the duration of the preceding signal.

In a particular implementation, said recordings are made, or optionally all of them are made at different points of the region, each attribute of said set of spectral attributes also being associated with a point. In other words, each attribute of the set of attributes is associated with a frequency and with a point, since the recording is itself associated with a point that may be different for different recordings.

In a particular implementation, said recordings are made over a predetermined duration and from a predetermined time.

It is preferable to select a starting time that is situated in the middle of the night (e.g. starting at midnight) with a duration of about four hours: this makes it possible to acquire signals during periods in which anthropic noise is at its lowest.

In a particular implementation, said recordings are made in groups of recordings that are made simultaneously, each group corresponding to a day during which the recordings of the group are made, the recordings being made at different points of said region and/or from different instants.

This particular implementation serves to study a region using a limited number of measurement apparatuses. In this particular implementation, the apparatuses are moved each day in order to be able to cover a region with good resolution.

In a particular implementation, the columns of said matrix associated with a given attribute are all adjacent. This particular implementation serves to make the influence of an attribute more observable compared with another attribute by making use of principal component analysis.

In a particular implementation, each group of recordings is associated with a group of rows of the matrix, and for each group of rows, the values of the attributes are normalized.

It may also be observed that in the matrix, these groups of rows may be grouped together by placing them consecutively in a common group.

Thus, since each group is associated with one day, normalizing serves to obtain attribute values that lie within the same ranges of values, even if changing the positions of the sensors shows up changes in the amplitudes of the signals acquired in the recordings. The normalization may be reduced centered normalization.

In a particular implementation, said principal components are projectors, and said matrix is projected onto each projector so as to obtain for each projector a graphical representation of said region showing the result of the projection of the matrix for each point. In a particular implementation, a number K of projectors is determined from among said projectors. In other words, the number of projectors is selected as a function of at least one criterion. By way of example, this criterion may serve to determine that a projector gives a good graphical representation of the subsurface of the region or of variation over time in the subsurface. The person skilled in the art knows how to assess this criterion as a function of data relating to the subsurface obtained by means other than those forming part of the invention properly speaking, or as a function of knowledge about the structure of the ground in the region.

For example, if the graphical representation is a gray scale map of the region, the K projectors may be determined by determining whether an anomaly appears at a location where variations are expected. By way of indication, the anomaly may correspond to the structural shape of a geological trap.

This particular implementation is particularly adapted to studying variations in a storage reservoir of extent that is known from initial analyses performed by other means (wells, etc. . . . ).

In a particular implementation, the method further comprises:
projecting said matrix onto said K projectors so as to obtain, for each row of said matrix, a vector of length K;
obtaining a second matrix from said vectors of length K;
applying to the second matrix a classification method that is organized in one or two dimensions in order to obtain N classes of rows;
allocating at least one class number to each row of the matrix representing a magnitude of an anomaly of the subsurface of the region;
preparing a class head for each class of rows;
obtaining a third matrix of dimensions N by K from said class heads; and
applying a pseudo-inversion method to said third matrix in order to obtain a fourth matrix of dimensions N times the number of frequencies appearing in each row of the initial matrix of spectral attributes.

The organized classification method may be a method well known to the person skilled in the art such as a self-organized map (SOM) or a generative topographic map (GTM).

N is selected to be strictly greater than 1, and it may be of the order of about ten or several tens.

For one-dimensional classification, a class number is allocated to each row to represent the magnitude of the anomaly (i.e. the variation in the spectra). These class numbers may be represented on a gray scale. Different rows may have the same class number.

If a two-dimensional classification is used, other methods of representation may be used, e.g. by combining two scales of complementary colors.

It may be observed that for each class number, it is possible to define a class head as the center of gravity of all of the rows to which the class number has been allocated. Alternatively, the class head may be the row closest to the center of gravity, and by way of example, this may be determined by a Euclidean metric.

Alternatively, the method further comprises:
projecting said matrix onto said K projectors so as to obtain, for each row of said matrix, a vector of length K;
obtaining a second matrix from said vectors of length K;
applying a pseudo-inversion method to said second matrix in order to obtain a third matrix having the same dimensions as said initial matrix of spectral attributes;
applying to the third matrix a classification method organized in one or two dimensions in order to obtain N classes of rows;
allocating at least one class number to each row of the matrix representing the magnitude of an anomaly of the subsurface of the region;
preparing a class head for each class of rows; and
obtaining from said class heads a fourth matrix of dimensions N times the number of frequencies appearing in each row of the initial matrix of spectral attributes.

In this variant, the pseudo-inversion step is performed before applying a classification method.

The invention also provides a system for characterizing the subsurface of a region, the system comprising:
a module for preparing a plurality of spectra representative of the spectral density of passive seismic signals obtained in the vicinity of the surface of said region at at least one point of said region where a recording is made of passive seismic signals, each spectrum being prepared from a signal representative of a movement;
a module for determining at least one spectral attribute for each frequency appearing in each spectrum suitable for obtaining a set of spectral attributes associated with recordings and with frequencies;
a module for organizing said set of attributes in a matrix in which each row is associated with a recording; and
a module for applying a principal component analysis method to said matrix in order to determine principal components in order to deduce therefrom the characteristics of said subsurface.

The system may be configured to perform all of the above-described implementations of the method.

The invention also provides a computer program including instructions for executing steps of the method as defined above when said program is executed by a computer.

It may be observed that the computer programs mentioned in the present disclosure may use any programming language, and may be in the form of source code, object code, or code intermediate between source code and object code, such as in a partially compiled form, or in any other desirable form.

The invention also provides a computer-readable data medium storing a computer program including instructions for executing steps of the method as defined above.

The data (or recording) medium mentioned in the present disclosure may be any entity or device capable of storing the program. For example, the medium may comprise storage means, such as a read only memory (ROM), e.g. a compact disk (CD) ROM or a microelectronic circuit ROM, or indeed magnetic recording means, e.g. a floppy disk or a hard disk.

Furthermore, the data media may correspond to a transmissible medium such as an electrical or optical signal, suitable for being conveyed via an electrical or optical cable, by radio, or by other means. The program of the invention may in particular be downloaded from an Internet type network.

Alternatively, the data media may correspond to an integrated circuit in which the program is incorporated, the circuit being adapted to execute or to be used in the execution of the method in question.

### BRIEF DESCRIPTION OF THE DRAWINGS

Other characteristics and advantages of the present invention appear from the following description made with reference to the accompanying drawings, which show an example having no limiting character.

In the figures:

FIG. 1 is a diagram showing the steps of a method in an implementation of the invention;

FIG. 2 is a diagram showing a system in an embodiment of the invention;

FIG. 3 is a section view of the subsurface of a region;

FIG. 4 is a diagram showing how a spectrum is obtained from a signal;

FIG. 5 shows the matrix in which attributes are organized;

FIG. 6 shows the projection of the matrix onto the projectors;

FIG. 7 is a graph showing the classification of re-projected vectors; and

FIG. 8 shows the graphical representation that is obtained after associating a parameter with each re-projected vector.

### DETAILED DESCRIPTION OF AN EXAMPLE

There follows a description of a method and a system for characterizing the subsurface of a region in accordance with a particular example of the invention.

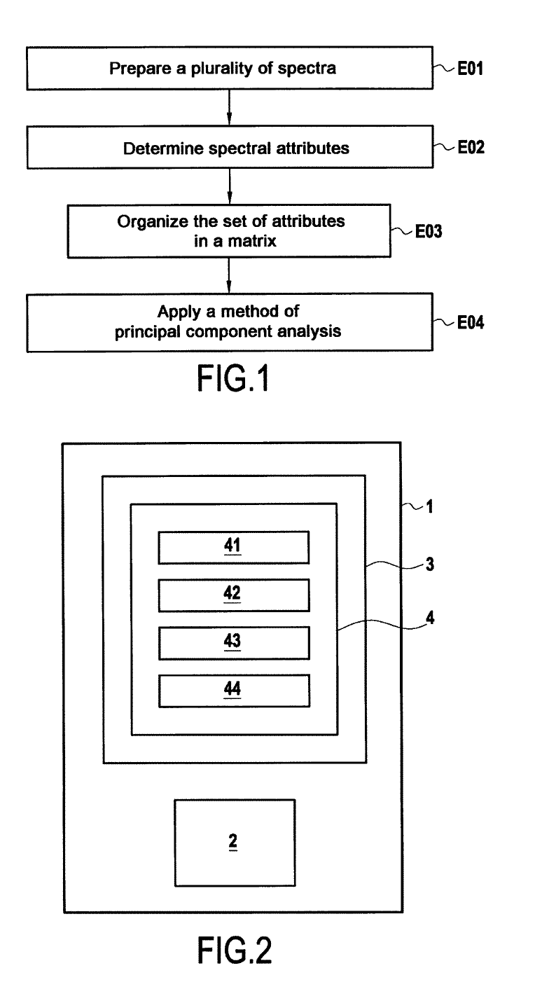

FIG. 1 is a diagram showing various steps in a method of characterizing the subsurface of a region.

The method may be performed to determine whether fluids or a plurality of phases of a single fluid are present in the subsurface of a region.

Typical applications for using this method relate for example to monitoring reservoirs containing hydrocarbons (e.g. natural gas), steam, and various types of gas (e.g. CO₂, H₂), prospecting for hydrocarbons, prospecting in the geothermal field.

In a first step E01 of the method, a plurality of spectra are prepared that illustrate the spectral density of passive seismic signals obtained in the vicinity of the surface of said region at at least one point of said region where passive seismic signals are recorded, each spectrum being prepared from a signal illustrating a movement.

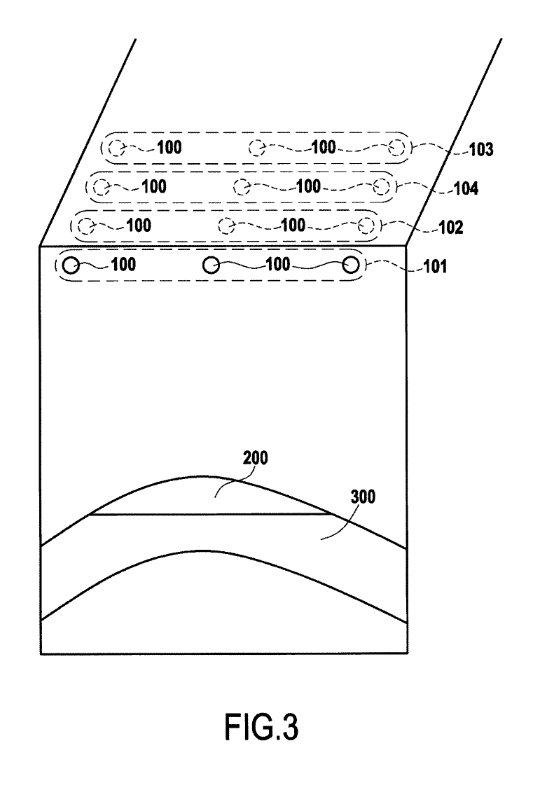

In other words, steps of acquiring signals illustrating horizontal movements (possibly two signals in different directions) and/or vertical movements are performed beforehand. These signals may be acquired by using seismometers, such as the apparatus sold by the Canadian supplier Nanometrics under the trade name “T-40”. Such apparatuses can be arranged regularly in the vicinity of the surface of a region or on the surface of the region, as described below with reference to FIG. 3, and the apparatuses are preferably used at night so as to reduce anthropic noise. All of the signals are associated with a respective instant and/or a respective location or point of the region under study.

It may be observed that apparatus of the kind mentioned above provides movement speed signals that are representative of the movement.

Each spectrum may be obtained from the signal corresponding thereto by determining the power spectral density (PSD) of the signal.

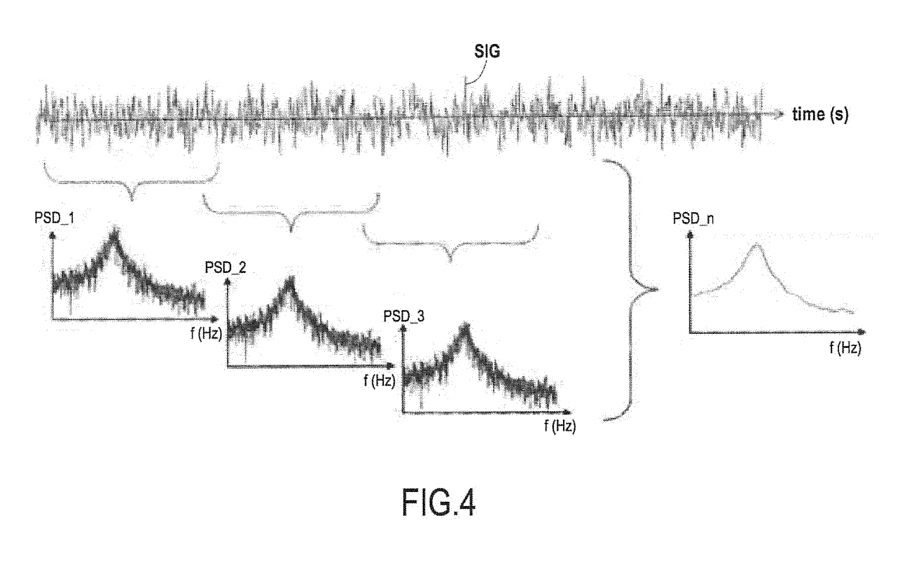

It is also possible to perform processing that seeks to smooth the spectrum that is obtained, as described below with reference to FIG. 4.

After step E01, spectra are obtained, or indeed spectra that may comprise both a spectrum associated with the horizontal movements and also a spectrum that is associated with the vertical movements, these spectra being associated with the recordings and thus with their properties as constituted by the point of the region and the instant or the day of acquisition.

It may be observed that obtaining a single spectrum for horizontal movements from two signals representative of movement in two different directions may be done by calculating the geometrical mean of the spectra corresponding to each direction. Specifically:

Fh(f)=\sqrt{PSD_{E}²+PSD_{N}²}

where f is frequency, Fh(f) is the spectrum corresponding to horizontal movements, PSD_{E} is the spectrum corresponding to horizontal movements in a first direction (specifically east), and PSD_{N} is the spectrum corresponding to horizontal movements in a second direction (specifically north).

Thus, the spectra are sampled and relate to a finite number of frequencies contained in a previously selected broad range.

In a second step E02, spectra attributes are determined. These attributes may be selected from the group formed by the ratio between the spectral density for vertical seismic movements and the spectral density for horizontal seismic movements, the derivative of the spectral density as a function of frequency for the horizontal seismic movements, and the derivative of the spectral density as a function of frequency for the vertical seismic movements.

These three attributes can be written as follows:

$$\frac{Fv ( f )}{Fh ( f )}$$

$$\frac{dFh ( f )}{df}$$

$$and$$

$$\frac{dFv ( f )}{df}$$

where Fv(f) is the spectrum corresponding to vertical movements.

It may be observed that the derivative of the spectral density as a function of frequency for the horizontal seismic movements and/or said derivative of the spectral density as a function of the frequency of vertical seismic movements can be calculated by applying a linear regression around a selected number of spectrum points.

By way of indication, the selected points may be obtained by dividing the frequency axis into spans of 0.5 Hz.

The step E02 serves to obtain a set of attributes associated with frequencies (which may differ between the different types of attributes), with the recordings, and thus with the points of the region, and also with the instants and/or the days at which the signals were acquired.

In a step E03, this set of attributes is organized into a matrix in which each row is associated with a recording (i.e. with one point of the region, and with one instant and/or one day when recording was made).

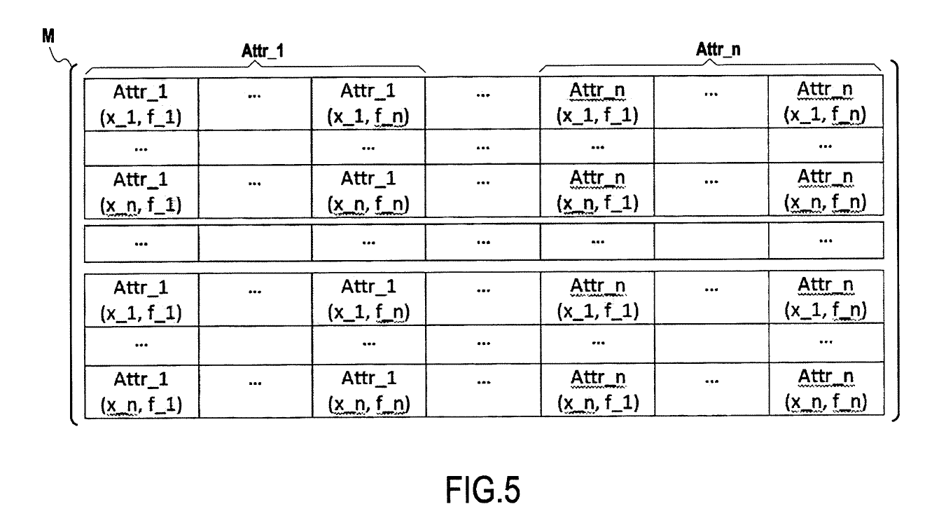

This organization is described in greater detail with reference to FIG. 5.

In a step E04, a method of principal component analysis is applied to said components in order to determine the principal components and deduce therefrom the characteristics of said subsurface.

FIG. 2 is a diagram showing a system 1 suitable for performing the steps E01 to E04 as described with reference to FIG. 1.

The system 1 may be a computer system and it comprises a processor 2 and a memory 3.

Instructions of a computer program 4 are stored in the memory 3. The computer program 4 comprises instructions 41 for performing the steps E01, instructions 42 for performing the step E02, instructions 43 for performing the steps E03, and instructions 44 for performing the step E04.

In combination, the instructions 41 to 44 and the processor together form modules of the system 1 that are adapted respectively to performing the steps E01 to E04.

FIG. 3 is a section view of the subsurface of a region that it is desired to characterize by performing the method of the invention.

For this purpose, seismometers 100 were buried in the vicinity of the surface of the region and seismometers 100 forming part of a group 101 can be seen in the plane of the section. By way of example, seismometers 100 were buried at a depth of about fifty centimeters. Such an installation is particularly simple for a technician.

Alternatively, the seismometers could be placed on the surface, providing that configuration enables good coupling to be obtained with the ground. The person skilled in the art knows how to place seismometers in order to obtain good coupling.

In this example, the subsurface of the region includes a zone 200 containing gas, and a zone 300 containing water. This region may be a reservoir. The presence of these two fluids with different phases makes it possible to perform the method of the invention.

In the example shown, in the groups 101, the seismometer 100 that is arranged in the middle of the figure will present spectra that are different from the spectra of the seismometers 100 that are arranged on the right and on the left, since only the middle seismometer is vertically above the reservoir.

In order to enable recordings to be made within a region with few apparatuses, it is possible to take measurements in groups.

For example, on a first day from midnight to 4 in the morning, the seismometers 100 are arranged to form the group 101 and acquire data. On a second day from midnight to 4 in the morning, the seismometers 100 are arranged to form the group 102 and acquire data. On a third day from midnight to 4 in the morning, the seismometers 100 are arranged to form the group 103 and acquire data. On a fourth day from midnight to 4 in the morning, the seismometers 100 are arranged to form the group 104 and acquire data.

FIG. 4 is a diagram showing how a spectrum is obtained from a signal, e.g. a signal obtained by the seismometers 100 described with reference to FIG. 3.

In this figure, there can be seen a signal SIG that is representative of movements, specifically of movement speed along one direction. The signal was acquired during a four-hour long acquisition starting from midnight: this serves to reduce the appearance of anthropic noise.

The signal SIG may be divided into a plurality of sub-signals that are all of the same duration, the sub-signals being consecutive, and each sub-signal in this example overlapping the preceding sub-signal over at least half of the duration of the preceding sub-signal (this overlap is not essential). In the figure, the sub-signals are represented by curly braces under the signal SIG.

It may be observed that some of the sub-signals may be omitted and not processed thereafter if they present excessive noise. By way of indication, it is possible to eliminate sub-signals having an absolute value that exceeds a threshold. For example, it is possible to exclude sub-signals that have an absolute value situated beyond the 99% quantile defined for the entire signal SIG.

Thereafter, a sub-spectrum is prepared for each sub-signal. In the figure, three spectral density sub-spectra are shown: PSD_1, PSD_2, and PSD_3.

For each frequency of the sub-spectra, a median value is determined for the spectral density on the basis of the spectral density values for that frequency in each sub-spectrum. The spectrum PSD_m is then obtained from all of the median values. In other words, the spectrum is made up of these median values.

FIG. 5 shows how attributes are organized within a matrix M for organizing attributes obtained for signals as acquired at different points and on days that may be different.

In the matrix M, the following notation is used:

Attr_i: attribute of type i;

x_j: point j in the region (this point is associated with the day of the measurement);

f_k: the frequency k of the spectral attribute. In the matrix M, each row is associated with a recording and with a point x_j of the region, and each column is associated with an attribute type Attr_i and with a spectral attribute frequency f_k.

In the matrix, the columns of the matrix that are associated with a given attribute are all adjacent. Thus, the rows of said matrix corresponding to groups of recordings made simultaneously (e.g. within the groups 101 to 104 described with reference to FIG. 3) are all grouped together in the matrix so as to form groups of rows, and each group is associated with one day in this example.

Preferably, for each day, or for each group of rows, the values of the attributes are normalized.

Organizing the attributes in the matrix M makes it possible to perform a method of principal component analysis in which each row is an individual and each column is a variable. The principal component analysis serves to obtain principal components that are referred to as “projectors”. The projectors are thus vectors written p, which are of length L that is equal to the product of the number of different attribute types multiplied by the number of frequencies present for each attribute type.

The projection of a row of index i (lying in the range 1 to m, which is the number of rows in the matrix M) of the matrix M onto a projector p is calculated as follows:

$$〈 M \vert p 〉 ( i ) = {\sum }_{j = 1}^{j = L} M ( i , j ) \cdot p ( j )$$

Since the result of this projection corresponds to a point of the region, it is possible to obtain a graphical representation of the projection of the matrix M at all points of the region where signal acquisitions were performed.

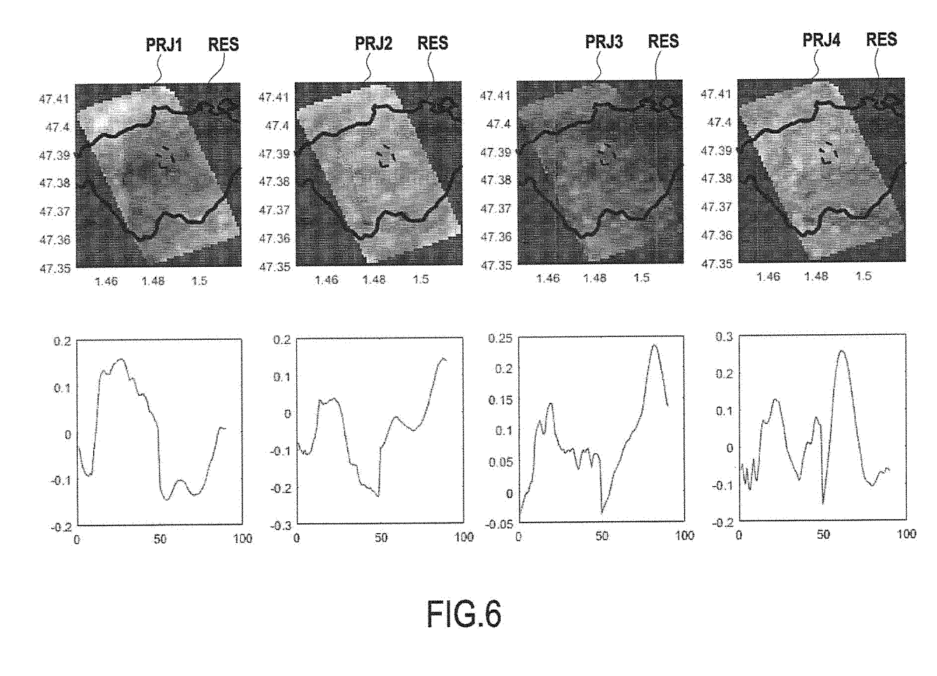

Such graphical representations are shown in FIG. 6. This figure shows four graphical representations corresponding to projections: PRJ1, PRJ2, PRJ3, and PRJ4. The outline of a known reservoir RES is highlighted on these graphical representations.

The graphical representations that present gray scale variations that correspond best to the expected spatial representation are considered as being good projectors. The person skilled in the art knows how to interpret these maps.

Under each graphical representation of the region, there is also shown the projector itself as a function of frequency.

In the example shown, the projectors PRJ1 and PRJ2 are considered to be good projectors. A number K of projectors is thus determined as being equal to two of the projectors, these projectors being written p1 and p2.

Thereafter, the matrix can be projected onto the two projectors p1 and p2 by using the following formula:

[symbol]

M|(p1,p2) [symbol] (i)=( [symbol] M|p1 [symbol] ), [symbol] M|p2 [symbol] )

This obtains a number m (the number of rows in the matrix, or the number of recordings) of vectors belonging to a two-dimensional space. These vectors may be organized to form the rows of a second matrix.

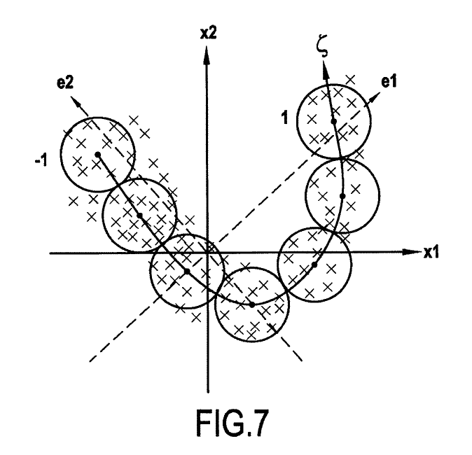

FIG. 7 shows the individuals present in this second matrix in their initial reference frame represented by the axis x1, x2. Each individual corresponds to a cross in the figure.

Thus, by applying a classification method organized in one dimension for obtaining N classes, it is possible to classify these individuals by determining a curve written ξ that approximates the individuals, and then by determining classes that are represented by circles on a curvilinear abscissa along the curve ξ that corresponds to a class number (that varies in this example from −1 to 1). It may be observed that the radius of the circles corresponds to their covariance radius.

This figure also shows the axes that correspond to the two projectors that have been retained, which axes are referenced e1 and e2 and do not enable the anomaly to be represented well enough.

In this example, the class number represents the magnitude of the anomaly in the subsurface of the region.

Thus, the centers of the circles are considered as class heads.

It is then possible to obtain a third matrix of dimensions N by K from the class heads. Thereafter, it is possible to perform pseudo-inversion of the matrix in order to obtain a fourth matrix of dimensions N times the number of frequencies appearing in each row of the initial matrix of the spectral attributes.

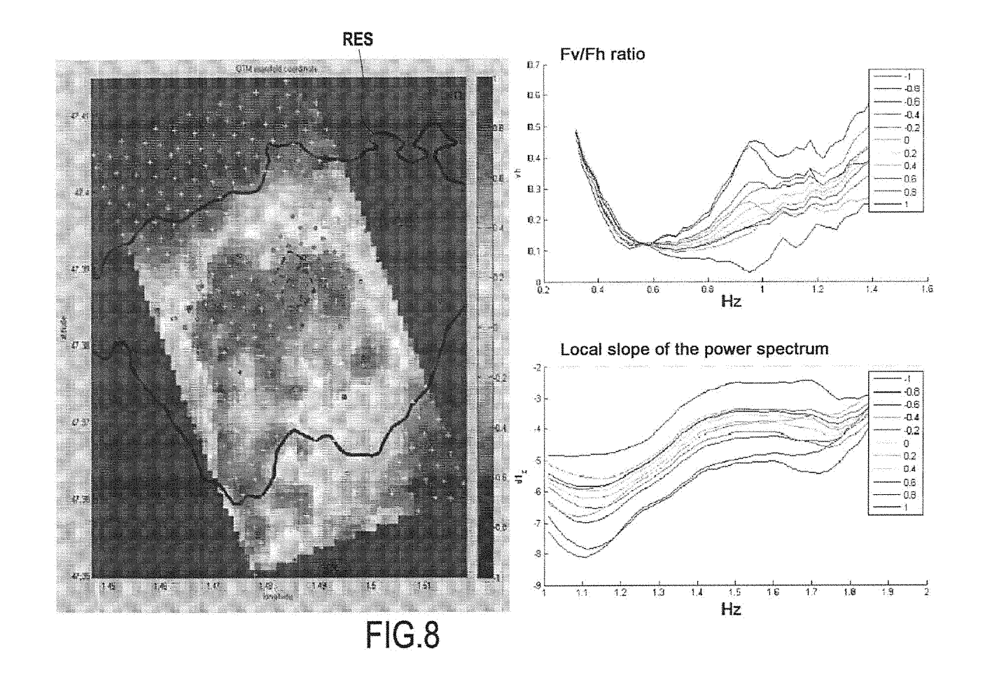

FIG. 8 shows the map that is obtained by displaying the value of the magnitude of the anomaly by means of a class number for each point of the region, it being possible to obtain this map after the pseudo-inversion.

In this figure, for each class head, there are also shown the curves that reveal the variations as a function of frequency in the attributes corresponding to the class heads, with this being done for two attributes, the derivative to the spectrum corresponding to the vertical movements as a function of frequency, and the ratio between the vertical and horizontal movements.

It should be observed that these curves show behaviors that are very different, including in frequency ranges that are lower than 1 Hz.

The inventors have observed that the peak specified by the document “Phenomenology of tremor-like signals observed over hydrocarbon reservoirs” (S. Dangel et al., Journal of Volcanology and Geothermal Research) is in fact preceded by a decrease in the spectrum when the measurement is taken vertically above a reservoir. By using a large frequency range, and by using principal component analysis, the invention enables anomalies to be shown up more clearly than in the solutions of the prior art.

It may also be observed that the various graphs shown in the present description were obtained from measurements taken over and around a known reservoir.

1. A method of characterizing a subsurface of a region, the method comprising:
preparing a plurality of spectra illustrating a spectral density of passive seismic signals obtained in a vicinity of a surface of the region at one or more points of the region where recordings are made of the passive seismic signals, each spectrum being prepared from an associated signal representative of a movement;
determining at least one spectral attribute for each frequency appearing in each spectrum so as to obtain a set of spectral attributes associated with the recordings and with the frequencies;
organizing the set of spectral attributes in a matrix in which each row is associated with one of the recordings; and
applying a principal component analysis method to the matrix in order to determine principal components and deduce therefrom one or more characteristics of the subsurface.

2. The method according to claim 1, wherein:
each movement comprises at least one of: a vertical movement or a horizontal movement; and
the spectral attributes for each frequency comprise at least one of: a ratio between a spectral density for vertical seismic movements and a spectral density for horizontal seismic movements, a derivative of the spectral density as a function of frequency for the horizontal seismic movements, and a derivative of the spectral density as a function of frequency for the vertical seismic movements.

3. The method according to claim 2, wherein at least one of the derivative of the spectral density as the function of frequency for the horizontal seismic movements or the derivative of the spectral density as the function of frequency for the vertical seismic movements are calculated by applying a linear regression around a selected number of spectral points.

4. The method according to claim 1, wherein preparing each spectrum from a signal comprises:
dividing the associated signal into a plurality of consecutive sub-signals all having a same duration:
preparing a spectral density sub-spectrum for each sub-signal;
for each frequency of the sub-spectra, determining a statistical attribute of the spectral density from spectral density values for that frequency in each sub-spectrum; and
obtaining the spectrum that is to be prepared from all of the statistical attributes of all of the frequencies.

5. The method according to claim 4, wherein each sub-signal other than a first of the sub-signals overlaps a preceding sub-signal over at least a non-zero duration of the preceding sub-signal.

6. The method according to claim 1, wherein the recordings are made at different points of the region, each attribute of the set of spectral attributes also being associated with one of the points.

7. The method according to claim 1, wherein the recordings are made over a predetermined duration and from a predetermined time.

8. The method according to claim 7, wherein:
the recordings are made in groups of recordings that are made simultaneously, each group corresponding to a day during which the recordings of the group are made, and
the recordings are made at different points of the region, from different instants, or at different points of the region and from different instants.

9. The method according to claim 1, wherein columns of the matrix associated with a given attribute are all adjacent.

10. The method according to claim 8, wherein:
each group of recordings is associated with a group of rows of the matrix, and
for each group of rows, values of the attributes are normalized.

11. The method according to claim 1, wherein:
the principal components are projectors, and
the matrix is projected onto each projector so as to obtain, for each projector, a graphical representation of the region showing a result of the projection of the matrix for each recording.

12. The method according to claim 11, wherein a number K of projectors is determined from among the projectors.

13. The method according to claim 12, further comprising:
projecting the matrix onto the K projectors so as to obtain, for each row of the matrix, a vector of length K;
obtaining a second matrix from the vectors of length K;
applying to the second matrix a classification method that is organized in one or two dimensions in order to obtain N classes of rows;
allocating at least one value to each row of the matrix representing a magnitude of an anomaly of the subsurface of the region;
preparing a class head for each class of rows;
obtaining a third matrix of dimensions N by K from the class heads; and
applying a pseudo-inversion method to the third matrix in order to obtain a fourth matrix of dimensions N times a number of frequencies appearing in each row of the matrix of spectral attributes.

14. The method according to claim 12, further comprising:
projecting the matrix onto the K projectors so as to obtain, for each row of the matrix, a vector of length K;
obtaining a second matrix from the vectors of length K;
applying a pseudo-inversion method to the second matrix in order to obtain a third matrix having same dimensions as the matrix of spectral attributes;
applying to the third matrix a classification method organized in one or two dimensions in order to obtain N classes of rows;
allocating at least one class number to each row of the matrix representing the magnitude of an anomaly of the subsurface of the region;
preparing a class head for each class of rows; and
obtaining from the class heads a fourth matrix of dimensions N times a number of frequencies appearing in each row of the initial matrix of spectral attributes.

15. A system for characterizing a subsurface of a region, the system comprising:
a memory configured to store instructions; and
a processor configured, when executing the instructions, to:
prepare a plurality of spectra representative of a spectral density of passive seismic signals obtained in a vicinity of a surface of the region at one or more points of the region where recordings are made of the passive seismic signals, each spectrum being prepared from an associated signal representative of a movement;
determine at least one spectral attribute for each frequency appearing in each spectrum so as to obtain a set of spectral attributes associated with the recordings and with the frequencies;
organize the set of spectral attributes in a matrix in which each row is associated with one of the recordings; and
apply a principal component analysis method to the matrix in order to determine principal components and deduce therefrom one or more characteristics of the subsurface.

16. The system according to claim 15, wherein:
each movement comprises at least one of: a vertical movement or a horizontal movement; and
the spectral attributes for each frequency comprise at least one of: a ratio between a spectral density for vertical seismic movements and a spectral density for horizontal seismic movements, a derivative of the spectral density as a function of frequency for the horizontal seismic movements, and a derivative of the spectral density as a function of frequency for the vertical seismic movements.

17. A non-transitory computer readable data medium storing a computer program including instructions that when executed cause a processor to:
prepare a plurality of spectra representative of a spectral density of passive seismic signals obtained in a vicinity of a surface of the region at one or more points of the region where recordings are made of the passive seismic signals, each spectrum being prepared from an associated signal representative of a movement;
determine at least one spectral attribute for each frequency appearing in each spectrum so as to obtain a set of spectral attributes associated with the recordings and with the frequencies;
organize the set of spectral attributes in a matrix in which each row is associated with one of the recordings; and
apply a principal component analysis method to the matrix in order to determine principal components and deduce therefrom one or more characteristics of the subsurface.

18. The non-transitory computer readable data medium according to claim 17, wherein:
each movement comprises at least one of: a vertical movement or a horizontal movement; and
the spectral attributes for each frequency comprise at least one of: a ratio between a spectral density for vertical seismic movements and a spectral density for horizontal seismic movements, a derivative of the spectral density as a function of frequency for the horizontal seismic movements, and a derivative of the spectral density as a function of frequency for the vertical seismic movements.

19. The non-transitory computer readable data medium according to claim 17, wherein the instructions that when executed cause the processor to prepare each spectrum comprise instructions that when executed cause the processor to:
divide the associated signal into a plurality of consecutive sub-signals all having a same duration:
prepare a spectral density sub-spectrum for each sub-signal;
for each frequency of the sub-spectra, determine a statistical attribute of the spectral density from spectral density values for that frequency in each sub-spectrum; and
obtain the spectrum that is to be prepared from all of the statistical attributes of all of the frequencies.

20. The non-transitory computer readable data medium according to claim 19, wherein each sub-signal other than a first of the sub-signals overlaps a preceding sub-signal over at least a non-zero duration of the preceding sub-signal.
